(19) United States
(12) Patent Application Publication
(10) Pub. No.: US 2003/0028637 A1
(43) Pub. Date: Feb. 6, 2003

(54) Method and apparatus for providing network access to a shared image projection device

(76) Inventor: Curtis T. Gross, Rocklin, CA (US)

Correspondence Address: HEWLETT-PACKARD COMPANY, Intellectual Property Administration, P.O. Box 272400, Fort Collins, CO, 80527-2400, US

(21) Appl. No.: 09/920,591

(22) Filed: Jul. 31, 2001

(51) Int. Cl. G06F 15/173

(52) U.S. Cl. 709/225

(57) ABSTRACT

An adapter for providing network access to a shared image projection device may comprise a network interface for connecting to a network and receiving network data from a network device over the network. A client, operatively associated with the network interface, receives data from the network interface and produces a data signal. A video display driver, operatively associated with the client, receives the data signal and produces video data for the shared image projection device.

### FIELD OF THE INVENTION

The invention relates generally to image projection devices, and more specifically, to a method and apparatus for providing network access to a shared image projection device.

### BACKGROUND

In a face-to-face meeting, it is often desirable, or even necessary, to show the meeting's participants a chart, graph, report or other information item so that the item can be discussed, edited, etc.

Often, information is shown to a meeting's participants by means of pre-printed paper handouts. However, such an approach is rather cumbersome in that it requires considerable time and planning before the meeting. Moreover, since the information is pre-printed, with each participant receiving his or her own copy of the information, it is difficult for meeting participants to collaborate on changes to the information.

Another means by which information may be shown to a meeting's participants is the overhead projector. With an overhead projector, information is printed onto a transparency instead of paper, and the information is then projected onto a wall or screen that all meeting participants are able to view. Transparencies are advantageous over paper handouts in that changes to transparencies may be viewed by all meeting participants. However, transparencies can sometimes be messy to write on, and erasures and/or re-writes on a transparency can diminish the quality of the transparency. Furthermore, it can be difficult to copy a transparency if it is later desired to give all of a meeting's participants a copy of the transparency.

Yet another means by which information may be shown to a meeting's participants is the data projector. With a data projector, information is transmitted to the data projector from a meeting participant's computer (e.g., a meeting participant's laptop computer). As with an overhead projector, the information is then projected onto a wall or screen that all meeting participants are able to view. Data projectors are advantageous over overhead projectors in that there is no need to create transparencies. Furthermore, it is easier to print a computer screen than it is to copy a transparency. However, data projectors are more cumbersome than overhead projectors and paper handouts in that only one meeting participant may connect his or her computer to a data projector, and thus, only one meeting participant may display information to the other meeting participants. To display information stored on the computer of a second meeting participant, the first meeting participant's computer has to be physically disconnected from the data projector, and the second participant's computer then needs to be connected to the data projector. Only after physically disconnecting and connecting the two computers is the second meeting participant able to display information to the meeting's participants. Furthermore, when the first meeting participant disconnects his or her computer from the data projector, the item which he or she had previously been displaying disappears, and there is no means by which the second meeting participant may connect to the data projector and continue editing the previously displayed item.

### SUMMARY OF THE INVENTION

In contrast to face-to-face meetings, some meetings are held virtually. In a virtual meeting, the meeting's participants need not be physically present in the same room. For example, each of the meeting's participants may log onto a network via his or her own computer, and then conduct a meeting via the network. Just as in face-to-face meetings, it is often desirable, or even necessary, to show the participants of a virtual meeting a chart, graph, report or other information item so that the item can be discussed, edited, etc. One means of showing information to the participants of a virtual meeting is via peer-to-peer software. For example, MICROSOFT® WINDOWS® NETMEETING® is a commonly used software application that allows a user to share information displayed on their computer with other participants in a virtual meeting. Using NETMEETING®, all of a meeting's participants may view and recommend changes to shared information (i.e., the participants may collaborate on information changes). If one or more meeting participants desire to print a hardcopy of the information, they may easily do so via a printer which they choose. A meeting participant may also choose to store a copy of the information on their own computer or elsewhere.

Unfortunately, the use of applications such as NETMEETING® is impractical in face-to-face meetings because participants in a face-to-face meeting are used to viewing information in either a pre-printed and/or projected form. The use of applications such as NETMEETING® during a face-to-face meeting would tend to discourage oral discussions, which oral discussions are usually the impetus for a face-to-face meeting in the first place.

Since many meeting participants attend face-to-face meetings with their computers (e.g., a laptop computer), it would be desirable if these meeting participants could share information with the ease provided by applications such as NETMEETING®, yet still maintain the conventional flow of a face-to-face meeting.

To assist in achieving such a result, the inventor has devised an adapter for providing network access to a shared image projection device. The adapter may comprise a network interface for connecting to a network and receiving network data from a network device over the network. A client, operatively associated with the network interface, receives data from the network interface and produces a data signal. A video display driver, operatively associated with the client, receives the data signal and produces video data for the shared image projection device.

Also disclosed is a method for providing network access to a shared image projection device that, according to one embodiment, comprises the steps of: connecting the shared image projection device to a network via a network adapter; receiving network data at the network adapter, the network data being received from another device which is connected to the network; and outputting video data from the network adapter to the shared image projection device, in response to the network data, whereby the network data is then displayed via the shared image projection device.

### BRIEF DESCRIPTION OF THE DRAWING

Illustrative and presently preferred embodiments of the invention are shown in the accompanying drawing in which:

FIG. 1 is a high level diagram illustrating the components of a network adapter, and a network and image projection device to which it may connect, according to one embodiment of the invention;

FIG. 2 illustrates the relationship between FIGS. 2A and 2B;

FIGS. 2A and 2B form a flow chart illustrating a method for providing network devices with network access to a shared image projection device according to one embodiment of the invention;

FIG. 3 illustrates a more expansive network in which the network adapter of FIG. 1 may be used; and

FIG. 4 is a schematic illustrating use of the FIG. 1 network adapter in conjunction with a network device implementing MICROSOFT® WINDOWS® NETMEETING®.

### DETAILED DESCRIPTION OF THE INVENTION

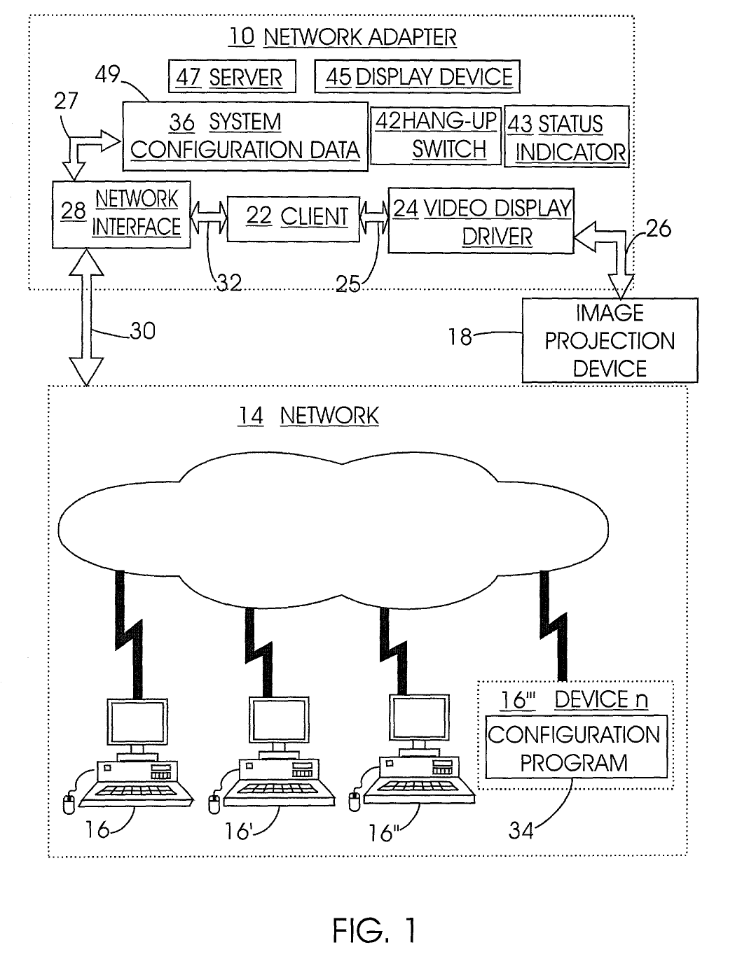

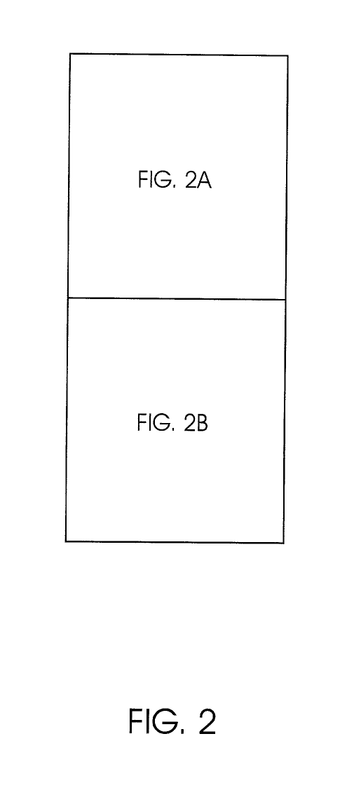

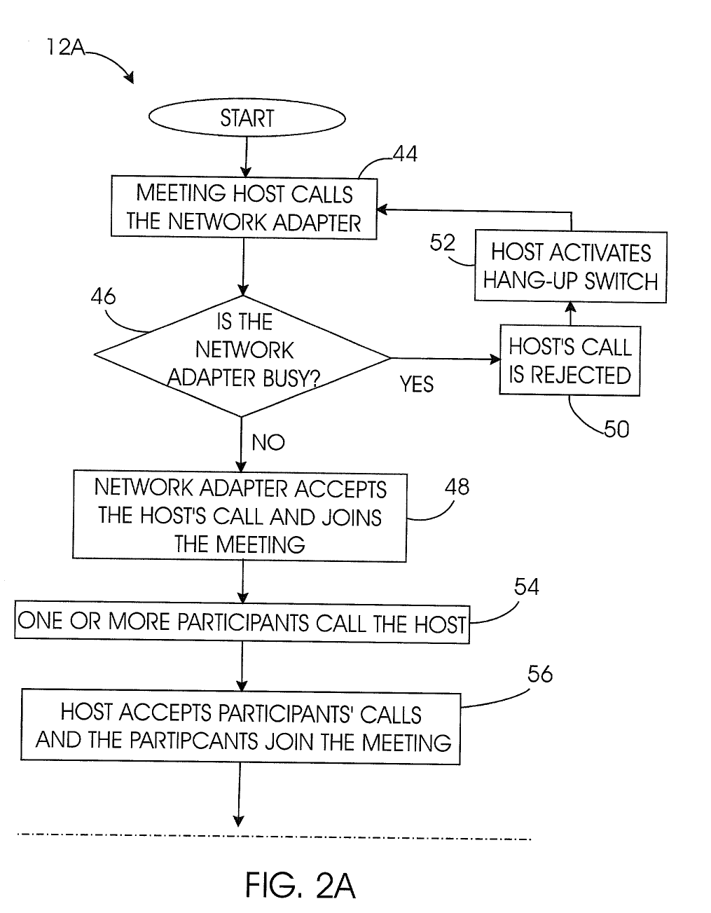

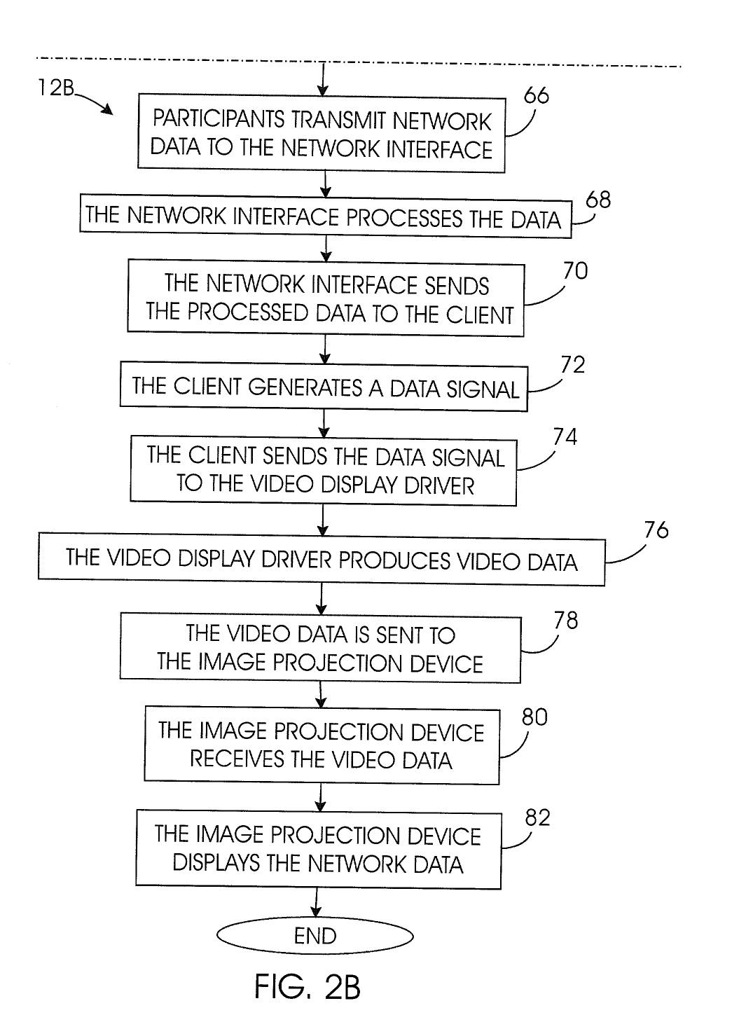

A network adapter 10 and method 12 according to one embodiment of the invention are shown in FIGS. 1, 2A and 2B and are described herein as they could be used in a network 14 to provide a number of (i.e., one or more) network devices 16, 16′, 16″, 16′″ with network access to a shared image projection device 18. That is, the invention allows one or more network devices (e.g., laptop computers, etc.) to share access to an image projection device without requiring repeated physical disconnection and connection of the network devices to the image projection device. Thus, the present invention provides a convenient and efficient way for meeting participants to share information via an image projection device.

It should be noted that the network adapter 10 may be used with any of a wide range of image projection devices, including devices which project an image onto their own screen (e.g., monitors, liquid crystal displays (LCDs), televisions, etc.) and devices which project an image onto a remote screen (e.g., data projectors). Preferably, the network adapter 10 is used with a data projector. Examples of currently available data projectors include the INFOCUS® and PROXIMA® data projectors available from InFocus Corporation, Wilsonville, Oreg. However, it should be noted that the network adapter 10 might also be used in conjunction with other image projection devices, which may be available now or developed in the future. Accordingly, the present invention should not be regarded as limited to the image projection device 18 which is shown and described herein.

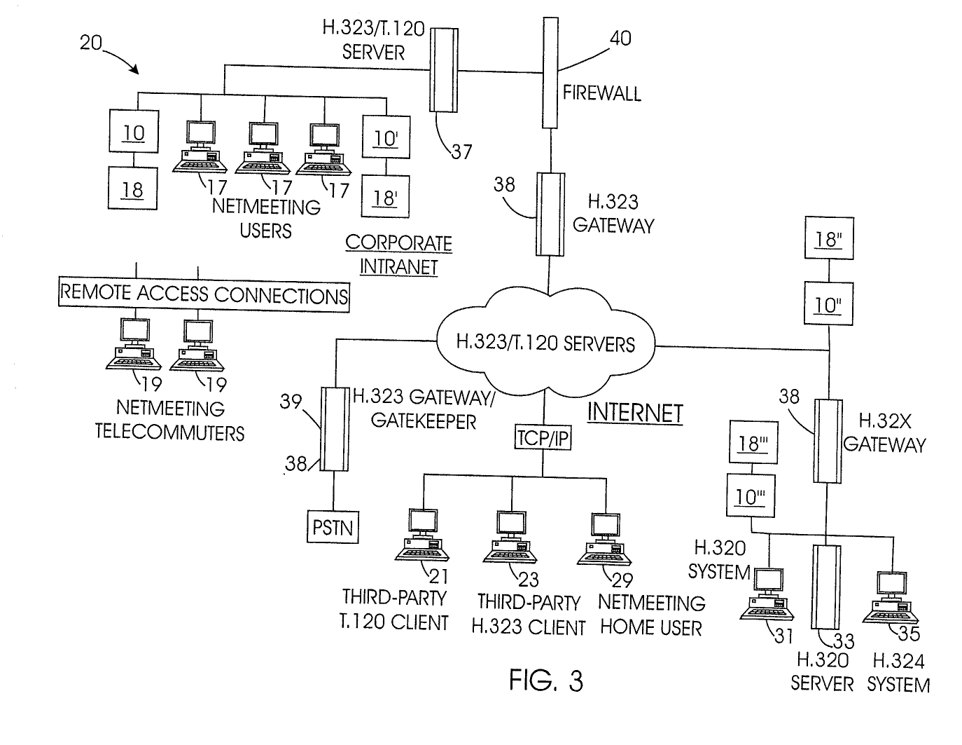

An exemplary network 14 in which the network adapter 10 may be used is shown in FIG. 1. It is to be understood, however, that the network 14 may be any suitable network (e.g., a local area network (LAN), a wide area network (WAN), an Intranet, the Internet, a combination thereof, etc.). For example, the network adapter 10 may be used in a more expansive network, such as a network 20 (FIG. 3) comprising a Corporate Intranet linked to the Internet. As shown in FIG. 3, one or more network adapters (e.g., 10, 10′, 10″, 10′″, etc.) may be used in the network 20 to provide shared access to one or more image projection devices (e.g., 18, 18′, 18″, 18′″) linked to the network 20.

It is to be understood that the arrangement shown in FIG. 3 is merely illustrative and is not intended to limit the scope of the present invention. Moreover, the present invention should not be regarded as limited to use with MICROSOFT® WINDOWS® NETMEETING® only. Indeed, the present invention may also be used with any of a wide range of other applications that allow network devices to share computer screens, desktops, other applications, etc., including, but not limited to, HEWLETT PACKARD® Visual Conference, SUN® SunForum, SGI® SGI Meeting, a combination thereof, etc.

Likewise, any number of devices 16, 16′, 16″, 16′″ may be linked to the network 14 or 20 via any suitable means (e.g., modem, T-1, digital subscriber line (DSL), infrared, etc.), including other devices (e.g., routers, hubs), other networks (e.g., LAN, WAN, Intranet, the Internet, etc.), etc. In one embodiment, the network devices 16, 16′, 16″, 16′″ comprise personal computers or client terminals. However, the network devices 16, 16′, 16″, 16′″ may be any suitable computers such as desktop personal computers, laptop computers, workstations, handheld computers (e.g., a PALM PILOT®), a combination thereof, etc. The network devices 16, 16′, 16″, 16′″ may also include, for example, peripheral devices (e.g., printers, scanners), storage devices, servers, routers, hubs, etc. Referring again to FIG. 3, in one embodiment, the network devices may comprise NETMEETING® users 17, NETMEETING® telecommuters 19, T.120 clients 21, H.323 clients 23, NETMEETING® home users 29, H.320 systems 31, H.320 servers 33, H.324 systems 35, H.323/T.120 servers 37, gateways 38, gatekeepers 39, firewalls 40, etc.

It should be noted that T.120, H.320, H.323 and H.324 are communication standards (i.e., protocols) set by the International Telecommunications Union (ITU), Geneva, Switzerland. More specifically, T.120 is the ITU standard for real-time data conferencing; H.320 is the ITU standard for videoconferencing over digital lines; H.323 is the ITU standard for real-time, interactive voice and videoconferencing over LANs and the Internet; and H.324 is the ITU standard for videoconferencing over analog telephone lines using modems. It should also be noted that in FIG. 3, TCP/IP is an acronym for Transmission Control Protocol/Internet Protocol, and PSTN is an acronym for Public Switched Telephone Network (i.e., the public telephone system).

Referring now primarily to FIG. 1, the network adapter 10 may comprise a “hard wired” box or stand-alone device that is operatively associated with the network 14 and with the image projection device 18. The network adapter 10 may also be housed within an image projection device which it services. Although the network adapter 10 may assume a variety of forms, it should be noted that the network adapter 10 is not a “general purpose” or “personal” computer, but is rather a “special-purpose”, “application-specific”, or “appliance-based” adapter.

The network adapter 10 may comprise a client 22, a video display driver 24, and a network interface 28, each of which may be embodied in hardware, firmware and/or software (i.e., hardware and/or computer readable program code). The firmware and/or software may be stored within one or more computer readable storage media located within the network adapter 10.

More specifically, the client 22 may comprise a T.120 client that may produce or generate output in response to data and/or commands it receives. For example, in one embodiment, the client 22 may receive T.120 packets from the network interface 28 via a link 32 and may generate data signals or output (e.g., DirectX for graphics, etc.) which are sent to the video display driver 24 via a link 25.

The video display driver 24 may provide the interface between the client 22 and the image projection device 18. Stated differently, the video display driver 24 may create video data or output in response to the data signals generated by the client 22. The video data produced by the video display driver 24 may then be sent via a link 26 (e.g., an RCA jack or VGA cable) to the image projection device 18 for display thereby.

To allow for communication between the network adapter 10 and one or more of the network devices 16, 16′, 16″, 16′″, the network adapter 10 may be provided with the network interface 28 and a link 30. The network interface 28 may provide an interface between the network devices 16, 16′, 16″, 16′″ and the network adapter 10, and the link 30 may provide the means through which data and/or commands may be transmitted. The link 30 may comprise any means for connecting the network adapter 10 to a network, including, for example, an RJ-45 cable.

The network data transmitted to the network adapter 10 by the network devices 16, 16′, 16″, 16′″ may be any suitable size and may take any suitable form, such as packetized data signals or network data packets. For example, the network data transmitted by the network devices 16, 16′, 16″, 16′″ may comprise packetized data signals from clients such as MICROSOFT® WINDOWS® NETMEETING®, HEWLETT PACKARD® Visual Conference, SUN® SunForum, SGI® SGIMeeting, a combination thereof, etc. In addition, the network data transmitted by the network devices 16, 16′, 16″, 16′″ to the network adapter 10 may be representative of, for example, an entire computer screen, a portion of a computer screen (e.g., an updated portion of a computer screen), or the contents of an application window. Likewise, the video data sent or outputted to the image projection device 18 may be representative of an entire computer screen, a portion of a computer screen, or the contents of an application window.

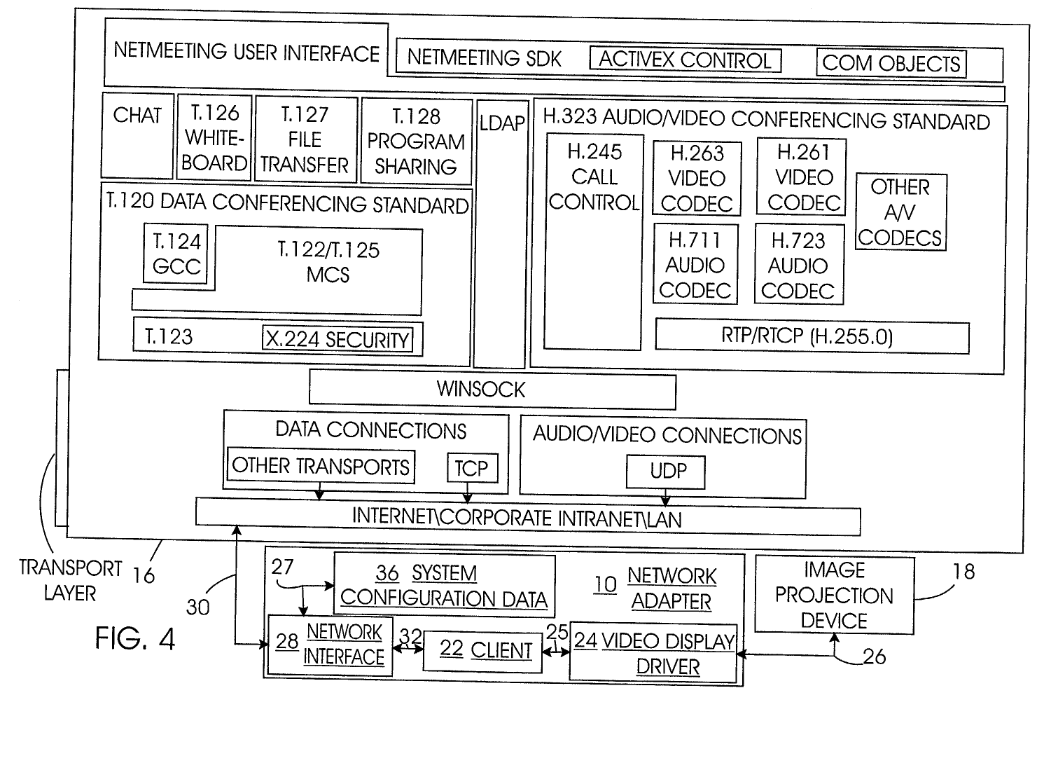

The network adapter 10 may be configured for use with protocols (e.g., T.120 protocol) that allow for peer-to-peer communication amongst network devices. Stated differently, the network adapter 10 may be configured for use with applications that allow network devices to share computer screens, desktops, other applications, etc. More specifically, the network adapter 10 may be configured for use with any of the wide range of applications that allow for the sharing of computer screens, desktops, other applications, etc. through the T.120 protocol. For example, the network adapter 10 may be configured for use with MICROSOFT® WINDOWS® NETMEETING®. See FIG. 4. As shown in FIG. 4, a network device 16 implementing MICROSOFT® WINDOWS® NETMEETING® may be used in conjunction with the network adapter 10. It should be noted, however, that the present invention is not limited to use with MICROSOFT® WINDOWS® NETMEETING® only. As mentioned earlier, the present invention may also be used in conjunction with any of a wide range of other applications that allow network devices to share computer screens, desktops, other applications, etc., including, but not limited to, HEWLETT PACKARD® Visual Conference, SUN® SunForum, SGI® SGIMeeting, a combination thereof, etc. Moreover, each of the meeting participants need not use the same application, but instead a combination of applications that allow network devices to share computer screens, desktops, other applications, etc. may be used with the network adapter 10.

In one embodiment, the network 14 may comprise a local area network (LAN), and the network interface 28 may comprise a LAN adapter. In such an embodiment, an exemplary operational sequence may comprise the network interface 28 receiving T.120 data packets within or wrapped inside 802.3 wrappers from one or more of the network devices 16, 16′, 16″, 16′″ via the link 30. The network interface 28 may then strip off or remove the 802.3 wrappers before sending the T.120 data packets to the client 22 so that the client 22 receives the T.120 data packets without the 802.3 wrappers. For example, in one embodiment, the network interface 28 may comprise computer readable program code for stripping the 802.3 wrappers from the T.120 data packets.

It should be noted that 802.3 is a standard set by the Institute of Electrical and Electronics Engineers (IEEE), New York, for a Carrier Sense Multiple Access/Collision Detection (CSMA/CD) local area network access method, which is widely implemented for communicating via an Ethernet.

After the network interface 28 has removed the 802.3 wrappers, the T.120 data packets may then be sent to the client 22 via link 32. Upon receipt thereof, the client 22 may generate data signals that are sent to the video display driver 24 via link 25. In response thereto, the video display driver 24 may then produce video data that is received by the image projection device 18 through link 26. The image projection device 18 may then display one or more images consistent with the T.120 data packets which were initially received by the network interface 28.

The network adapter 10 may have more than one mode of networking. For example, a first networking mode for the network adapter 10 may comprise Transmission Control Protocol/Internet Protocol (TCP/IP) that is facilitated by a static or permanent Internet Protocol address (IP address) configured into or assigned to the network adapter 10. Alternatively, the network adapter 10 may network via TCP/IP that is facilitated by a dynamic or Dynamic Host Configuration Protocol (DHCP) IP address delivered or assigned to the network adapter 10, for example, by a DHCP server.

The network adapter 10 may also include a peer-to-peer networking mode. The peer-to-peer networking mode may be in addition to or an alternative to the networking modes previously discussed for the network adapter 10. For example, if the network adapter 10 has not been configured with a static IP address, or if the network adapter 10 has been configured for DCHP but no DHCP server responds to a request by the network adapter 10 for a DCHP IP address, then the network adapter 10 may boot up in its peer-to-peer networking mode.

In the peer-to-peer networking mode, the network adapter 10 may communicate with a configuration program 34 to set configuration values or system configuration data 36 for the network adapter 10. The system configuration data 36 may include, but is not limited to, the dynamic or static IP address of the network adapter 10, the default gateway, the subnet mask, the computer name, the directory server, etc. The system configuration data 36 may be set automatically (i.e., without any user intervention), manually, via a combination thereof, etc.

Once the system configuration data 36 has been set, the network adapter 10 may reboot to allow the settings to take effect. After rebooting, the network adapter 10 may be accessed by the network devices 16, 16′, 16″, 16′″ and other T.120 clients linked to the network 14.

The configuration program 34 may be provided on one or more of the network devices 16, 16′, 16″, 16′″ (e.g., in FIG. 1, the configuration program 34 is installed on device 16′″). In one embodiment, the configuration program 34 may comprise firmware or software (i.e., computer readable program code) that is stored within one or more computer readable storage media of the network device 16′″. See FIG. 1.

The system configuration data 36 may be stored within one or more computer readable storage media of the network adapter 10. For example, in one embodiment, the system configuration data 36 may be stored within a memory 49 contained within the network adapter 10. Preferably, the memory 49 comprises a nonvolatile memory (e.g., flash memory, ROM, etc.), which allows the system configuration data 36 to be preserved even when the network adapter 10 is shut down, or when power is otherwise removed therefrom.

The network adapter 10 may further comprise an optional server 47, such as an HTTP or web server. Providing the network adapter 10 with the server 47 may allow the network adapter 10 to host the meeting for which the image projection device 18 is being used. However, it is generally preferable to have another network device (e.g., 16, etc.) host the meeting instead of the network adapter 10. Thus, the network adapter 10 need not be provided with the server 47.

As briefly mentioned earlier, the link 26 may allow the video display driver 24 to send video data to the image projection device 18. The link 26 may comprise any of a wide range of suitable connection means. In one embodiment, the network adapter 10 and the image projection device 18 are provided with VGA ports (not shown) into which may be plugged interconnection cables (not shown). In such an embodiment then, the link 26 may comprise interconnection cables plugged into the VGA ports through which the video display driver 24 may send video data to the image projection device 18. Alternatively, other links may be used for link 26, as would be obvious to persons having ordinary skill in the art after having become familiar with the teachings of the present invention.

Also mentioned earlier, the network devices 16, 16′, 16″, 16′″ may transmit network data and/or commands to the network adapter 10 by way of the link 30. While any of a wide range of well-known communication ports and formats may be utilized for the link 30, in one embodiment, the network adapter 10 is provided with a RJ-45 (Registered Jack-45) connector into which may be plugged twisted pair cabling or wiring. In such an embodiment then, the link 30 may comprise the twisted pair cabling plugged into the RJ-45 connector through which the network adapter 10 and the network devices 16, 16′, 16″, 16′″ may communicate. Alternatively, the network adapter 10 may instead be provided with an infra red (IR) serial port (not shown), and/or BLUETOOTH™ port (not shown), and the communications between the network adapter 10 and the network devices 16, 16′, 16″, 16′″ may be wireless. That is, the communications may take place through radio frequencies, infrared signals, etc. without the need for a wired connection or cabling. Alternatively, other links may be used for link 30 as would be obvious to persons having ordinary skill in the art after having become familiar with the teachings of the present invention.

With regard to the links 25, 27, and 32 between the various components of the network adapter 10, links 25, 27, and 32 may comprise buses that allow for communication between the various components of the network adapter 10. Alternatively, any of a wide range of other suitable links may be used for links 25, 27, and 32 as would be obvious to persons having ordinary skill in the art after having become familiar with the teachings of the present invention.

To obtain power for operation, the network adapter 10 may be provided with a power cable (not shown) that is linked to an external power supply. Alternatively, or in addition to the power cable, the network adapter 10 may be provided with an internal power source (e.g., a battery).

To facilitate management of (e.g., negotiate access to) the image projection device 18, the network adapter 10 may comprise an optional “hang-up” or reset switch 42. The hang-up switch 42 may revoke control of the image projection device 18 from a host or network device (e.g., 16, etc.) when activated. That is, the hang-up switch 42 may be used to terminate a call or connection between a network device (e.g., 16, etc,) and the network adapter 10. For example, the user may terminate or sever a connection between one of the network devices 16, 16′, 16″, 16′″ and the network adapter 10 and thus allow the network adapter 10 to join a different meeting. As another example, the hang-up button 42 could also be used to terminate or sever an “old” connection between one of the network devices 16, 16′, 16″, 16′″ and the network adapter 10 so that a new session or meeting may begin. The user may also want to terminate or sever a connection between the network adapter 10 and a network device that is “crashing the party” thereby allowing another network device to obtain control of the image projection device 18.

Regardless of the reason for terminating a call or connection, the hang-up switch 42 may comprise a mechanical switch provided on the network adapter 10. By manipulating (e.g., manually pushing) the mechanical switch, a user can terminate a call between the network adapter 10 and a network device (e.g., 16, 16″, 16″, 16′″, etc.). Alternatively, the hang-up switch 42 may be implemented with computer readable program code that communicates with the network adapter 10 via simple network management protocol (SMNP). In another embodiment, the hang-up switch 42 may be implemented as a user selectable interface (e.g., icon or dialog box) that is displayed on the screen of the meeting host (e.g., network device 16, etc.) and that is accessible by an input device associated with the meeting host (e.g., mouse, keyboard, etc.).

Preferably, the hang-up switch 42 would not be used for the various meeting participants to negotiate access to image projection device 18. Instead, the network adapter 10 is preferably another peer or participant within the meeting. For example, in one embodiment, the image projection device 18 may be coupled to a network (e.g., network 14, network 20, etc.) of meeting participant computers (e.g., network devices 16, 16′, 16″, 16′″, etc.) via the network adapter 10, and the network adapter 10 and the meeting participant computers may be configured as peers in a virtual meeting.

During the meeting in which the network adapter 10 is being used, the meeting participants may share information with (i.e., transmit network data for) the network adapter 10 and with the other participants in the same manner that the information would have been shared had the network adapter 10 not been a part of the meeting. For example, in one embodiment, network data shared during a meeting in which the network adapter 10 is being used will be displayed by the image projection device 18 and by the computer screens of the meeting participants. In such an embodiment, the image projection device 18 and computer screens function in a display mode that is commonly referred to as “slave mode.”

Other methods for negotiating access to the image projection device 18, however, are also possible. For example, a stack may be used to negotiate access to the image projection device 18. The stack may be maintained (i.e., persist) as long as the network adapter 10 is operational and linked to the network 14. In one embodiment, negotiation for access to the image projection device 18 may be performed on an interrupt basis such that the most recent requestor or caller is granted access to the image projection device 18. In such an embodiment, the stack may comprise a record of meetings, each of which contains a single participant. When a participant requests access to the image projection device 18, the participant's meeting is placed on the top of the stack, and the participant is granted access to the image projection device 18. Thus, the participant will have interrupted the previous meeting if one existed. Later, when the participant hangs up or terminates the call, the previous meeting that was interrupted may be resumed, with control of the image projection device 18 being returned thereto.

In an alternate embodiment, the stack may allow access to the image projection device 18 on a first-in, first-out (FIFO) basis. For example, if two or more requests for access to the image projection device 18 are made, access can be granted to the request that is received by the network adapter 10 first in time. In such an embodiment, the stack may comprise a record of the access requests and/or clients associated with those requests in the order in which the network adapter 10 receives those requests. When the network adapter 10 receives another request for access to the image projection device 18, that request may be placed at the bottom of the stack and will not have priority to the image projection device 18 until other pending requests are moved to the bottom of, or cleared from, the stack. A request may be popped off or cleared from the stack, or the request may be pushed or moved to the bottom of the stack, when the network device associated with that request relinquishes control of the image projection device 18. A request may also be cleared from or moved to the bottom of stack if the caller or requester has had control of the image projection device 18 but the caller has been inactive or idle for a configurable or predetermined amount of time. The hang-up switch 42 may also be used to clear a request from the stack or move a request to the bottom of the stack.

Use of the image projection device 18 may be governed by other than the interrupt or FIFO bases previously discussed. Indeed, any number of rules (i.e., one or more) may be used when determining priority and granting access to the image projection device 18, and such rules may be more complex or simple than those shown and described herein.

The network adapter 10 may further be provided with an optional lockout switch (not shown) that when activated locks out or prevents a particular network device or client from accessing the image projection device 18. By providing this feature, unwanted clients may be prevented from accessing the image projection device 18 and/or be prevented from “crashing the party.” Once a client or network device is locked out, that particular client may be prevented from accessing the image projection device 18 until the switch is reset. The switch may allow for a manual reset and/or an automatic reset. For example, the switch may automatically reset after the computer session terminates or after the expiration of a predetermined amount of time.

As before with the hang-up switch 42, the lockout switch may comprise a mechanical switch provided on the network adapter 10. Alternatively, the lockout switch may be implemented as a user selectable interface (e.g., icon or dialog box) that is displayed on the screen of the meeting host (e.g., network device 16, etc.) and that is accessible by an input device associated with the meeting host (e.g., mouse, keyboard, etc.). In another embodiment, the lockout switch may be embodied within the configuration program 34. For example, the configuration program 34, when setting the system configuration data 36, may identify certain network devices, clients, users, etc. that will be prevented from accessing the image projection device 18.

The network adapter 10 may further comprise an optional status indicator 43. The status indicator 43 may indicate whether the network adapter 10 is in use or busy (i.e., currently in a call). That is, the status indicator 43 may indicate whether a client or network device (e.g., 16, etc.) currently has control of the network adapter 10. The status indicator 43 may comprise an illumination apparatus, such as a light-emitting diode (LED), that generates light when the network adapter 10 is busy. Alternatively, the status indicator 43 may comprise an icon that is displayed on the screen of the meeting host (e.g., network device 16, etc.) and that is accessible by an input device associated with the meeting host (e.g., mouse, keyboard, etc.).

Preferably, a single switch would be provided that incorporates the hang-up feature, the lockout feature, and the status indication feature. Alternatively, any of a wide range of other devices may be utilized to provide the network adapter 10 with the hang-up, lockout, and status indication features just discussed as would be obvious to persons having ordinary skill in the art after having become familiar with the teachings of the present invention.

As shown in FIG. 3, one or more network adapters (e.g., 10, 10′, 10″, 10′″) may be active (i.e., operational) on a particular network (e.g., network 20). In such a scenario, some means may be provided for distinguishing the various network adapters 10, 10′, 10″, 10′″ on the network 20. In one embodiment, the network adapter 10 may be configured (e.g., provided with firmware or software) to register itself with a directory server, such as a user location service (ULS) or Internet locator service (ILS) directory server, when the network adapter 10 is powered or booted up. By doing so, the network adapter 10 may then be located on a network 20 by accessing the directory maintained by the directory server on which the network adapter 10 registered. For example, the network adapter 10 may be configured to register with a MICROSOFT® Internet Locator Service (ILS) server when the network adapter 10 is booted or powered up so that the network adapter 10 may be located by accessing the MICROSOFT® Internet Directory.

Optionally, the name under which the network adapter 10 has been registered (i.e., the name by which the network adapter 10 is referenced) may be provided to the meeting participants, for example, verbally or electronically. In one embodiment, the network adapter 10 may be provided with a display screen 45 (FIG. 1), such as an LCD display, upon which is displayed the name under which the network adapter 10 is registered.

In an alternate embodiment, peer-to-peer discovery mechanisms may be used to distinguish the various network adapters 10, 10′, 10″, 10′″ on the network 20. In this embodiment, the various network adapters 10, 10′, 10″, 10′″ may each be provided with a display apparatus (e.g., in FIG. 1, the network adapter 10 is provided with the display screen 45) such as a LCD display, upon which may be displayed a name by which to reference the corresponding network adapter 10, 10′, 10″, 10′″. When a network adapter (e.g., 10, etc.) becomes inactive and later reactivates, the network adapter 10 may send out a broadcast message over the network 20 looking for other network adapters 10′, 10″, 10′″ linked to the network 20. Once the other network adapters 10′, 10″, 10′″ are found, the names or identifiers associated therewith are discovered and a unique name or identifier (i.e., one not in conflict with the identifiers or names of other network adapter 10′, 10″, 10′″) may be assigned to the network adapter 10. The names or identifiers for the various network adapters 10, 10′, 10″, 10′″ on the network 20 may then be used in conjunction with MICROSOFT® WINDOWS® NETMEETING® or other screen sharing software (e.g., HEWLETT PACKARD® Visual Conference, SUN® SunForum, SGI® SGIMeeting, etc.) to gain access to the image projection device 18.

To allow for easier identification and location of the network adapter 10, an intuitive naming or identification scheme may be employed. By doing so, the need of providing the network adapter 10 with the display screen 45 for displaying the name or identifier under which the network adapter 10 is registered may be eliminated. For example, the network adapter 10 may register with the directory server under the name of the conference room for the meeting in which the network adapter 10 is going to be used. Alternatively, the name or identifier may comprise the IP address (e.g., dynamic IP address, static IP address, etc.) of the network adapter 10.

The network adapter 10, according to one embodiment, may be operated in accordance with the method 12 illustrated in FIGS. 2A and 2B. It is to be understood that FIGS. 2A and 2B are merely illustrative and are not intended to limit the teachings of the present invention.

As shown in FIG. 2A, a first step 44 of method 12 may comprise a meeting host (e.g., network device 16, etc.) calling the network adapter 10. At step 46, a determination may be made as to whether the network adapter 10 is busy (i.e., involved in another meeting or call). If it is determined at step 46 that the network adapter 10 is not busy, the network adapter 10 may accept the host's call and join the meeting at step 48. However, if it is determined at step 46 that the network adapter 10 is busy, the network adapter 10 may reject the host's call at step 50. If so, the hang-up switch 42 may then be used at step 52 to terminate the caller currently having control of the image projection device 18. At step 44, the host may again call the network adapter 10. If so, a determination may be made again at step 46 as to whether the network adapter 10 is busy. This time, however, since the connection between the network adapter 10 and the previous caller or host was terminated at step 52 by activation of the hang-up switch 42, and assuming that the network adapter 10 did not accept any other host calls thereafter, it will be determined at step 46 that the network adapter 10 is not busy. Thus, the network adapter 10 may accept the host's call and join the meeting at step 48. Although the network adapter 10 may host the meeting, it is generally preferable to have another network device or a conferencing server (not shown) host the meeting.

Assuming now that a participant wants to join the meeting in which the network adapter 10 is being used, a participant may call the host (i.e., the network device hosting the meeting) at step 54 and be accepted into the meeting at step 56. Although it is not shown, steps 54 and 56 may be repeated as necessary for the other participants wanting to join the meeting.

Referring now to FIG. 2B, one or more of the various participants in the meeting may transmit network data (e.g., T.120 data packets within 802.3 wrappers) to the network interface 28 via link 30 at step 66. Upon receipt thereof, the network interface 28 may strip off or remove the 802.3 wrappers at step 68 before sending the T.120 data packets to the client 22 via link 32 at step 70. In response to the T.120 data packets, the client 22 may generate a data signal at step 72 and may send the data signal to the video display driver 24 via link 25 at step 74. The video display driver 24 may then produce at step 76 video data consistent with the data signal sent by the client 22. Next, the video data may be sent via link 26 to the image projection device 18 at step 78. The image display device 18 may receive the video data from the video display driver 24 at step 80. Finally, at step 82, the image projection device 18 may display the network data (e.g., one or more images consistent with the T.120 data packets) sent by the participant(s) back at step 66. Although it is not shown in method 12, the network data, in addition to being displayed by the image projection device 18, may also be displayed on the computer screens of the meeting participants.

It is to be understood that the computer readable program code described herein can be conventionally programmed using any of a wide range of suitable computer readable programming languages that are now known in the art or that may be developed in the future. It is also to be understood that the computer readable program code can include one or more functions, routines, subfunctions, and subroutines, and need not be combined in a single package but may instead be embodied in separate components. In addition, the program code can reside within the network adapter 10 or it can have one or more components that reside at one or more locations on the network 14 or 20.

Although it is envisioned that the invention disclosed herein will be implemented in software or firmware code, such need not be the case. That is, the invention may be implemented through hardware, firmware, etc., or a combination thereof. Moreover, it is believed that a disclosure of the computer readable program code is not necessary, as one skilled in the programming arts should be able to generate such code without undue experimentation given the disclosure of the invention found herein. Accordingly, the details associated with the programming of the computer readable program code itself will not be discussed in further detail herein.

It is contemplated that the inventive concepts herein described may be variously otherwise embodied and it is intended that the appended claims be construed to include alternative embodiments of the invention except insofar as limited by the prior art.

What is claimed is:

1. An adapter for providing network access to a shared image projection device, comprising:
a network interface for connecting to a network and receiving network data from a network device over the network;
a client, operatively associated with the network interface, said client receiving data from the network interface and producing a data signal; and
a video display driver, operatively associated with the client, for providing video data to the shared image projection device, said video display driver receiving the data signal produced by the client and producing said video data.

2. The adapter of claim 1, further comprising at least one computer readable storage media storing system configuration data, wherein said system configuration data allows the adapter to be identified on and accessed over the network.

3. The adapter of claim 2, further comprising display apparatus, said display apparatus displaying at least a portion of said system configuration data.

4. The adapter of claim 2, wherein said at least one computer readable storage media comprises a nonvolatile memory.

5. The adapter of claim 1, further comprising a server, said server allowing said adapter to host a meeting for which the shared image projection device is being used.

6. The adapter of claim 1, wherein said client comprises a T.120 client.

7. The adapter of claim 1, wherein the network data comprises a T.120 data packet within an 802.3 wrapper, wherein said network interface removes the 802.3 wrapper from the T.120 data packet, and wherein said client receives the T.120 data packet without the 802.3 wrapper.

8. The adapter of claim 1, further comprising a hang-up switch, said hang-up switch terminating a connection between a network device and said adapter when said hang-up switch is activated.

9. The adapter of claim 1, further comprising a status indicator, said status indicator indicating the status of said adapter.

10. The adapter of claim 1, wherein the adapter comprises the shared image projection device.

11. A method for providing network access to a shared image projection device, comprising:
connecting the shared image projection device to a network via a network adapter;
receiving network data at said network adapter, said network data being received from another device which is connected to the network; and
outputting video data from said network adapter to the shared image projection device, in response to the network data, whereby the network data is then displayed via the shared image projection device.

12. The method of claim 11, wherein the network data comprises a T.120 data packet within an 802.3 wrapper; the method further comprising removing the 802.3 wrapper from the T.120 data packet after the network data is received by the network adapter.

13. The method of claim 11, further comprising setting system configuration data for said network adapter, said system configuration data allowing said network adapter to be identified on and accessed over the network.

14. The method of claim 13, further comprising displaying at least a portion of said system configuration data.

15. The method of claim 13, further comprising:
providing said network adapter with at least one computer readable storage media; and
storing said system configuration data within said at least one computer readable storage media.

16. The method of claim 11, further comprising registering said network adapter with a directory server.

17. A system, comprising:
a shared image projection device;
an adapter for providing network access to the shared image projection device, said adapter comprising:
a network interface for connecting to a network and receiving network data from a network device over the network;
a client, operatively associated with the network interface, said client receiving data from the network interface and producing a data signal; and
a video display driver, operatively associated with the client, for outputting video data to the shared image projection device, said video display driver receiving the data signal produced by the client and producing said video data.

18. The system of claim 17, further comprising:
a host computer for hosting a meeting for which the shared image projection device is being used; and
a configuration program operatively associated with said host computer and said adapter, said configuration program accessing said adapter to set system configuration data, said system configuration data allowing said adapter to be identified on and accessed over the network.

19. The system of claim 18, wherein said host computer comprises at least one computer readable storage media; and wherein said configuration program comprises computer readable program code stored within the at least one computer readable storage media of said host computer.

20. The system of claim 18, wherein said adapter further comprises at least one computer readable storage media; and wherein said system configuration data is stored within the at least one computer readable storage media of said adapter.

21. The system of claim 18, wherein said adapter further comprises a nonvolatile memory; and wherein said system configuration data is stored within the nonvolatile memory of said adapter.

22. The system of claim 17, wherein said shared image projection device is a data projector.

23. The system of claim 17, wherein said adapter is housed within said shared image projection device.

24. A method for viewing information during a meeting, comprising:
coupling a data projector to a network of meeting participant computers via a network adapter; and
configuring the network adapter and meeting participant computers as peers in a virtual meeting.
